(19) United States
(12) Patent Application Publication
(10) Pub. No.: US 2026/0268089 A1
(43) Pub. Date: Sep. 10, 2026

(54) CONDUCTING COMMUNICATION SESSIONS BASED ON MACHINE LEARNING CLASSIFICATION OF USER INTERACTION

(71) Applicant: Cisco Technology, Inc., San Jose, CA (US)

(72) Inventors: Liam C. Frawley, Galway (IE); Niall L. McDonnell, Galway (IE); Keith Griffin, Galway (IE)

(21) Appl. No.: 19/073,659

(22) Filed: Mar. 7, 2025

(51) Int. Cl. G06F 40/35

(52) U.S. Cl. CPC G06F 40/35

(57) ABSTRACT

An example embodiment automatically classifies portions of an audio or digital interaction as a good or bad experience based on silence and/or crosstalk. The example embodiment automatically detects silence and crosstalk, and uses this information and a set of criteria to classify an interaction with a user as a good (positive) or bad (negative) experience. The example embodiment combines machine learning (ML) language model analysis of transcripts, silence detection, and crosstalk detection, to classify portions (e.g., silence and crosstalk) of an audio interaction as a good (positive) or bad (negative) experience for the user. A communication may be marked for live coaching or review based on the classifications of the interactions of the agent with users.

### TECHNICAL FIELD

The present disclosure relates to communication and routing.

### BACKGROUND

A customer may call a contact center to communicate with a human agent of the contact center for assistance with respect to a product or service. The contact center attempts to provide the customer with a good experience of an interaction with the agent, whether the customer and agent interact over voice, video, or chat. As another example, an online business meeting between participants attempts to provide the participants with a good experience during the meeting. However, an agent or meeting participants may not provide the desired experience.

### BRIEF DESCRIPTION OF THE DRAWINGS

FIG. 1 is a block diagram of an example contact center environment in which machine learning classification of user interaction may be implemented, according to an example embodiment.

FIG. 2 is a block diagram of an example online communication environment in which machine learning classification of user interaction may be implemented, according to an example embodiment.

FIG. 3 is a flowchart of a method for classifying silence within a user interaction, according to an example embodiment.

FIG. 4 is an illustration representing silence within audio of a user interaction, according to an example embodiment.

FIG. 5 is a flowchart of a method for classifying crosstalk within a user interaction, according to an example embodiment.

FIG. 6 is an illustration representing crosstalk within audio of a user interaction, according to an example embodiment.

FIG. 7 is a flow diagram for classifying silence and/or crosstalk within a user interaction, according to an example embodiment.

FIG. 8 is a schematic illustration of an example user interface providing information for contact center agents pertaining to user interactions within communication sessions, according to an example embodiment.

FIG. 9 is a flowchart of a method for routing a communication to an agent of a contact center based on user interactions, according to an example embodiment.

FIG. 10 is a flow diagram for routing a communication to an agent of a contact center based on user interactions, according to an example embodiment.

FIG. 11 illustrates a flowchart of a generalized method for machine learning classification of user interaction, according to an example embodiment.

FIG. 12 illustrates a flow diagram of hardware block diagram of a computing device configured to perform functions associated with machine learning classification of user interaction as discussed herein, according to an example embodiment.

### DETAILED DESCRIPTION

### Overview

An example embodiment automatically classifies portions of an audio or digital interaction as a good or bad experience based on silence and/or crosstalk. The example embodiment automatically detects silence and crosstalk, and uses this information and a set of criteria to classify an interaction with a user as a good (positive) or bad (negative) experience. The example embodiment combines machine learning (ML) language model analysis of transcripts, silence detection, and crosstalk detection, to classify portions (e.g., silence and crosstalk) of an audio interaction as a good (positive) or bad (negative) experience for the user. A communication may be marked for live coaching o r review based on the classifications of the interactions of the agent with users.

### Example Embodiments

An example embodiment automatically detects and analyzes silence and/or crosstalk of a user interaction within an audio or digital communication session and classifies the user interaction as a good (positive) or bad (negative) experience for a user. The communication session may include any communication (e.g., voice, video, chat or other messaging, etc.) between any users (e.g., a customer and a contact center agent, online meeting participants, etc.). The example embodiment employs a machine learning classifier that uses silence and/or crosstalk information and a set of criteria to classify the user interaction. The classification may be performed in real-time or near real-time during a communication session, or performed based on a recording of the communication session. The classifications may be used for various purposes (e.g., identify areas for training contact center agents, routing communications in a contact center, conducting communication sessions with participants selected based on the classifications, etc.).

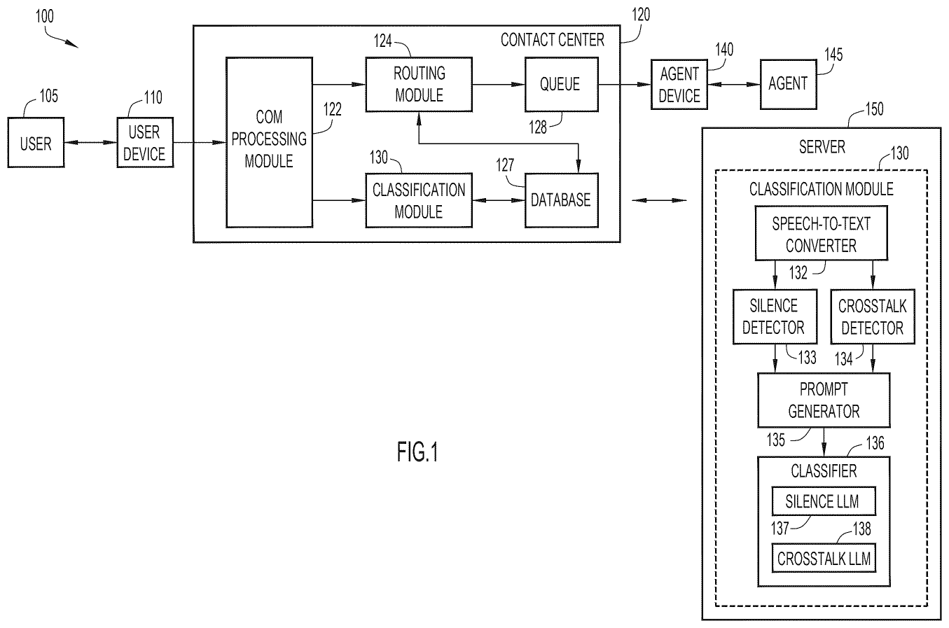

FIG. 1 is a block diagram of an example contact center environment 100 in which machine learning classification of user interaction may be implemented, according to an example embodiment. Contact center environment 100 includes one or more user devices 110 operated by users 105, one or more agent devices 140 operated by contact center agents 145 (e.g., persons, etc.), and a contact center 120 to support communication sessions (e.g., calls, chats, etc.) between the user devices and corresponding agent devices. The contact center routes user communications to agent devices 140 of contact center agents 145 that may provide various support to the users 105 with respect to any products or services (e.g., process requests, provide information, assist with use of a product or service, billing issues, etc.). User devices 110 and agent devices 140 can take on a variety of forms, including a smartphone, tablet, laptop computer, desktop computer, video conference endpoint, corresponding accessories (e.g., headset, etc.), and the like.

The communication session may be conducted over any suitable communication networks. For example, the communication networks may include one or more wide area networks (WANs), such as the Internet, one or more local area networks (LANs), and/or cellular or other telephony networks. User devices 110 may communicate over the communication networks using a variety of known or hereafter developed communication protocols. For example, user devices 110, agent device 140, and contact center 120 may exchange Internet Protocol (IP) data packets, Realtime Transport Protocol (RTP) media packets (e.g., audio and video packets), and so on.

Contact center 120 matches users 105 to contact center agents 145 to handle user requests or communications. The contact center classifies user interactions with contact center agents 145, and maintains information for the user interactions. The information is used to select a contact center agent to handle a communication (e.g., call, chat, email or other message, etc.), and to route the communication to the selected contact center agent.

Contact center 120 includes a communication processing module 122, a routing module 124, a database 127 to store information for agents pertaining to user interactions, and a communication queue 128 to hold communications for routing. Contact center 120 may further include a classification module 130 to classify user interactions as described below. Alternatively, classification module 130 may reside on a server system 150 coupled to contact center 120 over a network to classify user interactions. In this case, communications may be provided from contact center 120 for classification. For example, classification module 130 may be implemented as a microservice in a cloud environment.

Communication processing module 122 initially receives a communication from user 105 via user device 110 (e.g., an audio or video call, chat, email or other message, etc.). The communication processing module may obtain information about the user and/or communication. For example, the communication processing module may enable interaction with a user (e.g., via an interactive voice response (IVR) system, etc.), or analyze text of messages to obtain information (e.g., reason for the communication, user information, etc.). The information is provided to routing module 124 to route the communication from queue 128 to a contact center agent 145 that can handle the communication.

Routing module 124 of contact center 120 obtains information from database 127 pertaining to user interactions with contact center agents 145. The information is provided to database 127 by classification module 130 as described below. The routing module selects a contact center agent 145 to handle the communication based on the user interactions of the contact center agents as described below. Routing module 124 routes the communication from queue 128 to an agent device 140 of the selected contact center agent 145 to conduct a communication session between the selected agent 145 and corresponding user 105. The agent device enables communication between agent 145 and corresponding user 105.

Further, communications between users 105 and contact center agents 145 are provided to classification module 130 to classify user interactions as described below. The communications may be provided in real-time or near real-time during a communication session, or from a recording of the communication session. The classification module includes a speech-to-text converter 132, a silence detector 133, a crosstalk detector 134, a prompt generator 135, and a machine learning (ML) classifier 136. The speech-to-text converter converts audio of the communications to text or a transcript. Speech-to-text converter 132 may include any conventional or other converter that converts audio to text (e.g., Automatic Speech Recognition (ASR), etc.). The speech-to-text converter may employ any quantity of any conventional or other machine learning and/or natural language processing (NLP) models (e.g., mathematical/statistical models, classifiers, feed-forward (fully or partially connected), recurrent (RNN), convolutional (CNN), or other neural networks, deep learning models, long short-term memory (LSTM), attention-based methods/transformers, large language model (LLM), entity extraction, relationship extraction, part-of-speech (POS) taggers, semantic analysis, etc.) that are configured to convert the audio to text. By way of example, speech-to-text converter 132 may include a neural network as described below to convert audio to text.

The transcript is provided to silence detector 133 and/or crosstalk detector 134. In the event the communication session includes messages (e.g., chat, email or other messaging, etc.), the messages may be provided directly to silence detector 133 and/or crosstalk detector 134 (e.g., without speech to text conversion). Silence detector 133 detects instances of silence within the communication session as described below, while crosstalk detector 134 detects instances of crosstalk (e.g., simultaneous or overlapping communications between the user and contact center agent) within the communication session as described below.

Prompt generator 135 receives the silence and crosstalk detections, and generates prompts for classifier 136 to classify instances of silence and crosstalk detected within the communication session as a good (positive) or bad (negative) user experience. The prompts preferably include portions or sections of the communication session preceding and subsequent the instances of silence and crosstalk as described below. Text subsequent (or after) an instance of silence can supply significant context to a conversation between the agent and the user that can be important for classifying the instance as a good (positive) or bad (negative) experience for the user.

Classifier 136 receives the prompts and classifies the instances of silence and crosstalk between the user and contact center agent as a good (or positive) experience for the user or a bad (or negative) experience for the user. By way of example, classifier 136 includes a silence LLM 137 to classify instances of silence, and a crosstalk LLM 138 to classify instances of crosstalk. Prompt generator 135 generates a prompt for each LLM to classify respective instances of silence and crosstalk. However, classifier 136 may employ any quantity of any conventional or other large language models (LLM) and natural language processing (NLP) techniques to process the request and provide requested information and/or perform actions. The LLM and techniques can parse and understand text, and extract various elements, data types, tasks, and other relevant information. This information can be used to classify the user interaction. Silence LLM 137 and crosstalk LLM 138 may receive a corresponding prompt or natural language instruction (e.g., including, or in combination with, the transcript, etc.) from prompt generator 135, and process the prompt to determine a classification for the user interaction based on silence or crosstalk, respectively. The prompts may include several variations and forms.

Silence LLM 137 and crosstalk LLM 138 may be adapted or trained for the classification via any conventional or other techniques. By way of example, these LLMs may be trained based on a few-shot technique. This technique provides examples within a prompt in order to guide or control the behavior of the LLM to produce the desired output. The examples include an input and the desired output (e.g., text of interactions of good (or positive) experiences and the desired good (or positive) classification, text of interactions of bad (or negative) experiences and the desired classification of bad (or negative), etc.).

However, classifier 136 may include any quantity of any conventional or other machine learning and/or natural language processing (NLP) models (e.g., mathematical/statistical models, classifiers, feed-forward (fully or partially connected), recurrent (RNN), convolutional (CNN), or other neural networks, deep learning models, long short-term memory (LSTM), attention-based methods/transformers, large language model (LLM), entity extraction, relationship extraction, part-of-speech (POS) taggers, semantic analysis, etc.) that are configured (or trained) to classify the user interaction.

By way of example, the LLMs or other machine learning models of classifier 136 may include, or be implemented by, a neural network. For example, neural networks may include an input layer, one or more intermediate layers (e.g., including any hidden layers), and an output layer. Each layer includes one or more neurons, where the input layer neurons receive input (e.g., text or text features, etc.), and may be associated with weight values. The neurons of the intermediate and output layers are connected to one or more neurons of a preceding layer, and receive as input the output of a connected neuron of the preceding layer. Each connection is associated with a weight value, and each neuron produces an output based on a weighted combination of the inputs to that neuron. The output of a neuron may further be based on a bias value for certain types of neural networks (e.g., recurrent types of neural networks).

The weight (and bias) values may be adjusted based on various training techniques. For example, the machine learning of the neural network may be performed using a training set of various text (e.g., user interactions, etc.) as input and corresponding desired outputs (e.g., good (positive) or bad (negative) classification, etc.), where the neural network attempts to produce the provided output and uses an error from the output (e.g., difference between produced and known outputs) to adjust weight (and bias) values (e.g., via backpropagation or other training techniques).

The output layer neurons may indicate a probability for the input data being associated with a corresponding output (e.g., good (positive) or bad (negative) classification, etc.). The output with the highest probability may be selected as the result.

Classifier 136 may be trained to classify a user interaction based on silence, crosstalk, or a combination of silence and crosstalk. The classifier may include one or more machine learning models trained as described above to classify the user interaction (e.g., a machine learning model to classify the user interaction based on silence, a machine learning model to classify the user interaction based on crosstalk, an overall machine learning model to classify the user interaction based on either silence or crosstalk or a combination of silence and crosstalk, a machine learning model to classify the user interaction based on a combination of silence and crosstalk, etc.).

Further, various feedback may be provided for continuous training of the machine learning models (e.g., human feedback, etc.) to improve accuracy. For example, a feedback mechanism may be used to obtain information for an outcome of an interaction from customers, agents, and/or supervisors. Continuous learning may be performed to improve performance of the machine learning models over a period of time.

Moreover, the machine learning models may be continuously updated or trained with acceptable deviations (e.g., from user interactions classified as good (or positive)) in order to classify a user interaction. For example, a contact center agent may adhere to a script indicating a manner to communicate with users. The script may include a greeting, signoff, and/or other information to direct agent behavior during a communication session. The script may yield a greater amount of good (or positive) classifications for user interactions. However, an agent may deviate slightly from the script, where the deviation is sufficiently similar to the script and should yield a classification of a good (or positive) user interaction. Classification module 130 may determine deviations for the script (e.g., generated deviations, deviations from prior user interactions, etc.) and use the deviations to train (or fine tune or update) the machine learning models to classify the deviations as a good (or positive) interaction. A semantic model may be employed to determine semantic similarity of deviations to the script for training the model (e.g., to generate deviations of sufficient similarity to (or of a sufficient distance from) the script (relative to a threshold), to determine whether deviations in prior user interactions are sufficiently similar to (or of a sufficient distance from) the script (relative to a threshold), etc.). The similarity or distance may be determined (e.g., between feature vectors for the script and deviations) using any conventional or other techniques (e.g., Euclidean distance, cosine similarity, etc.). By way of example, the deviations may be used as examples in the prompts for good (or positive) classifications to adjust the silence and crosstalk LLMs.

By way of example, present embodiments are described with respect to user interactions with agents of a contact center. However, it will be appreciated that the techniques of example embodiments may be performed with respect to any types of user interactions or communication sessions (e.g., telephone calls, online meetings, emails, chats, threads, etc.) of any media (e.g., audio, video, text, etc.).

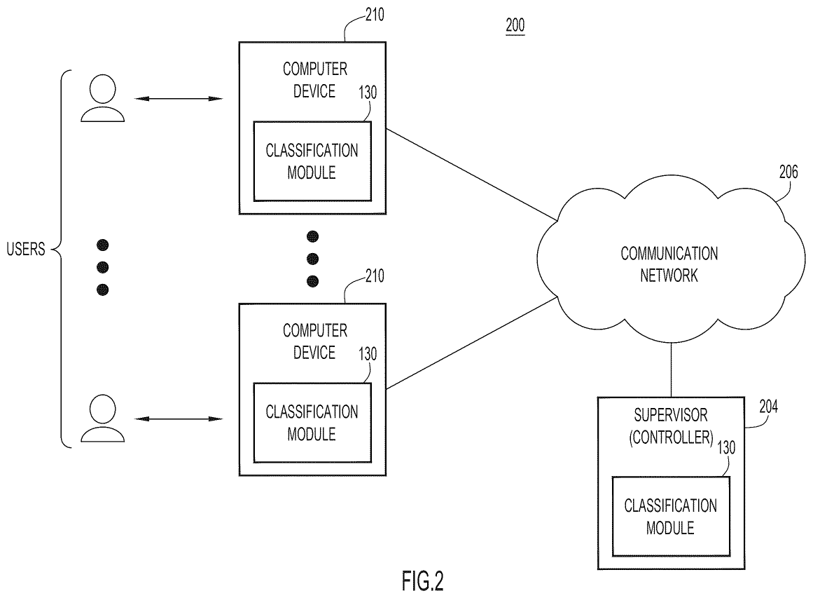

For example, FIG. 2 is a block diagram of an example online communication environment 200 in which an embodiment presented herein may be implemented. Online communication environment 200 includes multiple computer devices 210 (collectively referred to as computer devices, participant devices, or platforms) operated by local users/participants, a supervisor or server (also referred to as a “controller”) 204 configured to support online (e.g., web-based or over-a-network) communication or collaborative sessions (e.g., meetings, chat, conversations or other threads, webinars, etc.) between the computer devices, and a communication network 206 communicatively coupled to the computer devices and the supervisor. Computer devices 210 can take on a variety of forms, including a smartphone, tablet, laptop computer, desktop computer, video conference endpoint, and the like.

Communication network 206 may include one or more wide area networks (WANs), such as the Internet, and one or more local area networks (LANs). Computer devices 210 may communicate with each other, and with supervisor 204, over communication network 206 using a variety of known or hereafter developed communication protocols. For example, the computer devices 210 and supervisor 204 may exchange Internet Protocol (IP) data packets, Realtime Transport Protocol (RTP) media packets (e.g., audio and video packets), and so on.

Supervisor 204 or other server system coupled to communication network 206 may host a classification module 130 substantially similar to the classification module described above. According to embodiments presented herein, classification module 130 enables conversion of audio of communication sessions with user interactions to text, and classification of silence and crosstalk within the communication sessions as good (positive) or bad (negative) experiences for the user as described below. Computer devices 210 may each host a communication or collaboration application used to establish/join online communication or collaboration sessions. In an embodiment, computer devices 210 may host classification module 130 to classify user interactions in substantially the same manner described below. Meetings or communication sessions of a user of a computer device 210 may be provided to classification module 130 on computer device 210 and/or supervisor 204 for processing. The classifications may be used to initiate and/or conduct online meetings with participants that have good (positive) experiences or interactions with each other (e.g., select certain participants based on the classifications, select certain speakers/presenters based on the classifications, etc.).

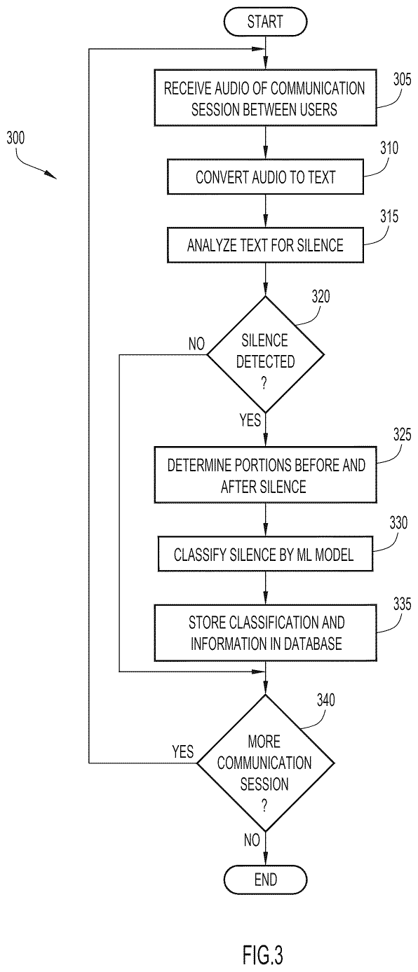

With continued reference to FIGS. 1 and 2, FIG. 3 illustrates a method 300 for classifying silence within a user interaction, according to an example embodiment. Initially, users may interact in a communication session (e.g., a user with a contact center agent, participants of an online meeting, etc.). Classification module 130 receives audio of the communication session at operation 305. The audio may be a recording of the communication session, or may be provided in real-time or near-real time during the communication session. In case of the audio being received during the communication session, the audio may be partitioned into segments of any desired time interval or duration (e.g., a few seconds to a few minutes, etc.). Speech-to-text converter 132 converts the audio to text to produce a transcript at operation 310. The transcript includes communications between the users during the communication session, and provides timestamps for the communications (e.g., a timestamp for each word or other token of text, etc.).

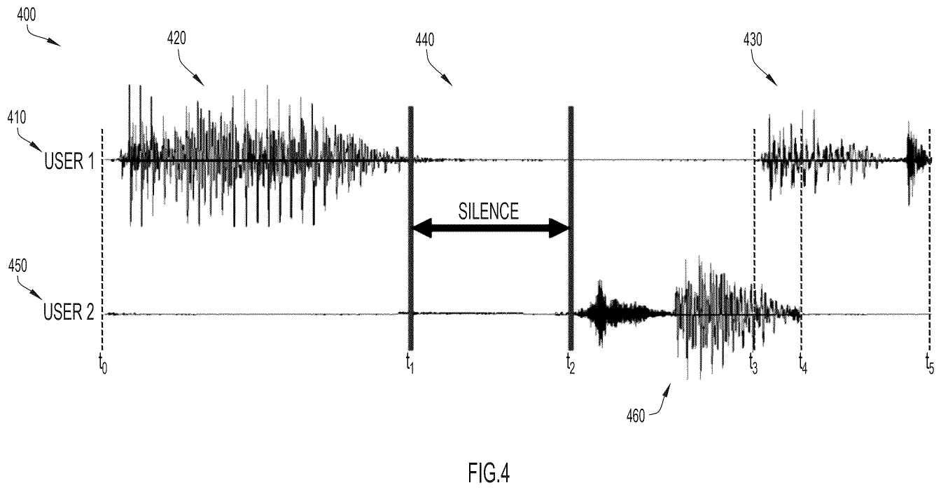

Silence detector 133 analyzes the transcript to identify silence (or dead air (DA)) in the communication session at operation 315. Silence can be automatically detected when there is no audio in a portion of the user interaction. Referring to FIG. 4, graphical representation 400 illustrates example audio of user interaction in a communication session between a user 410 (e.g., User 1 as shown in FIG. 4) and a user 450 (e.g., User 2 as shown in FIG. 4). The graphical representation is plotted on an X-axis representing time and a Y-axis representing amplitude. Audio for user 410 includes an initial audio portion 420 and a subsequent audio portion 430 each corresponding to sound or speech of user 410. Audio for user 450 includes an audio portion 460 corresponding to sound or speech of user 450. Audio portion 460 occurs in time between audio portions 420, 430 and slightly overlapping audio portion 430. A silence (or dead air) portion 440 resides in time between audio portions 420, 430, and prior to audio portion 460. Silent portion 440 includes an absence of sound or speech by each user 410, 450. In other words, the silent portion includes a region of representation 400 lacking audio portions 420, 430, and 460.

Silent portion 440 can be automatically detected when there is no audio in a portion of the communication session. This may be represented in the transcript based on timestamps for the audio portions of users 410, 450. For example, silent portion 440 may correspond to a period of time within the transcript when no audio portions of users 410, 450 are present. By way of example, audio portion 420 may reside between times t₀ and t₁, audio portion 430 may reside between times t₃ and t₅, and audio portion 460 may reside between times t₂ and t₄. Since no audio portions are present between times t₁ and t₂, this region or period of time represents silent portion 440. Silence detector 133 may analyze the timestamps in the transcript to identify silence. Alternatively, silence detector 133 may analyze the audio to detect silence (without text conversion). Speech-to-text converter 132 converts the audio to text as described above to produce the transcript for silence LLM 137. The timestamps of the silence from the audio correspond to the timestamps of the transcript. Silence detector 133 may determine the difference between timestamps (e.g., time or gap between words, etc.), and identify silence when the difference (or duration) exceeds a threshold, such as five seconds. However, any quantity of seconds may be used, where the threshold may be configurable as a parameter.

When silence is detected as determined at operation 320, prompt generator 135 receives the transcript and identification of silence (e.g., time period of silence), and determines portions or sections within the transcript preceding and subsequent the silence at operation 325. For example, prompt generator 135 may identify a quantity of sentences (e.g., one to five sentences or clauses, etc.) before and after the silence by comparing the time period of the silence with timestamps within the transcript. Prompt generator 135 generates a prompt for silence LLM 137 of classifier 136 to classify the silence as a good (positive) or bad (negative) user experience. By way of example, the prompt may include the portions preceding and subsequent the silence, the time period of the silence, and one or more examples of text for good (positive) and bad (negative) user experiences. However, the prompt may include any suitable information (e.g., the transcript, the silence, the portions preceding and subsequent the silence, examples, various context information, etc.).

Silence LLM 137 processes the prompt to classify the silence as a good (positive) or bad (negative) user interaction (or user experience) at operation 330. The classification may be based on a usefulness of the interaction. For example, the portions of text surrounding (preceding and subsequent) the silence indicating a resolution of an issue (e.g., product/service, topic, etc.) for the user indicate a good (or positive) user experience. Further, the portions of text surrounding (preceding and subsequent) the silence indicating the user receiving appropriate information for the issue indicate a good (or positive) user experience. Moreover, the portions of text surrounding (preceding and subsequent) the silence indicating a reason for (or expectedness of) the silence indicate a good (or positive) user experience. In contrast, the portions of text surrounding (preceding and subsequent) the silence indicating a failure to resolve an issue, failure to provide appropriate information for the issue, and/or failure to provide a reason for the silence (e.g., unexpected silence) indicate a bad (or negative) user experience. The prompt for silence LLM 137 may include examples of the text described above for indicating good (positive) and bad (negative) user experiences to direct behavior of the silence LLM for classifying the silence.

Classification module 130 stores the classification and corresponding information in database 127 at operation 335. For example, the classification module may determine various attributes and/or metrics pertaining to the user interaction (e.g., duration of interaction, duration of silence, overall duration for agent interactions, classification result, scores for users, etc.).

The above process repeats from operation 305 until the communication session has been processed as determined at operation 340. Thus, each instance of silence in the communication session is classified as a good (positive) or bad (negative) experience. The classifications and corresponding information may be used to determine scores for each instance, communication session, and/or user (e.g., contact center agent, meeting participant, etc.).

By way of example, a user interaction of a communication session between the user and a contact center agent for an issue (e.g., support for product/service, etc.) may include:
User 1: I don't know why that's happening.
Silence: (15 seconds; based on a difference between timestamps for the last word (happening) from User 1 and the first word (Hello) from User 2)
User 2: Hello, are you still there?
User 1: Yes, I'm still here.

This user interaction is likely an example of a bad (or negative) user interaction since User 1 did not provide a reason for the silence before or after the silence. In other words, the silence was unexpected.

By way of example, another user interaction within a communication session between the user and a contact center agent for an issue (e.g., support for product/service, etc.) may include:
User 1: Give me a moment while I figure out what's happening.
Silence: (15 seconds; based on a difference between timestamps for the last word (happening) from User 1 and the first word (Are) from User 2)
User 2: Are you able to determine what's happening?
User 1: I think so, yes.

This user interaction is likely an example of a good (or positive) user interaction since User 1 indicated a reason for the silence (e.g., to determine what is happening, etc.). In other words, the silence was expected.

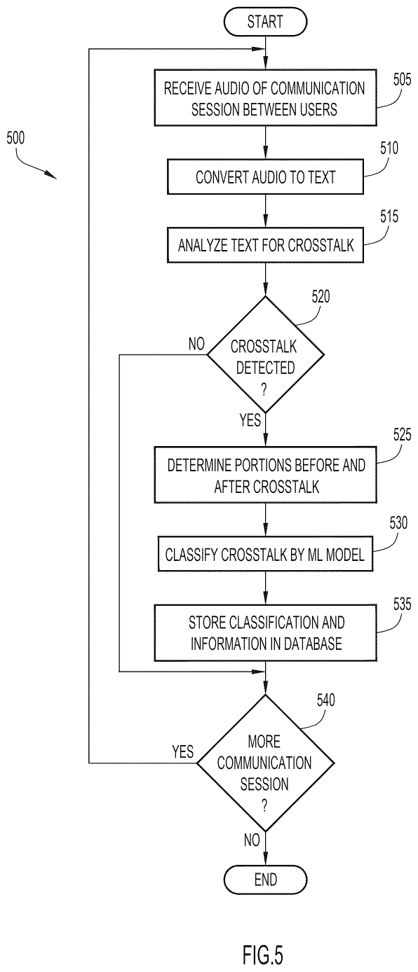

With continued reference to FIG. 1-4, FIG. 5 illustrates a method 500 for classifying crosstalk within a user interaction, according to an example embodiment. Initially, users may interact in a communication session (e.g., a user with a contact center agent, participants of an online meeting, etc.). Classification module 130 receives audio of the communication session at operation 505. The audio may be a recording of the communication session, or may be provided in real-time or near-real time during the communication session. In case of the audio being received during the communication session, the audio may be partitioned into segments of any desired time interval or duration (e.g., a few seconds to a few minutes, etc.). Speech-to-text converter 132 converts the audio to text to produce a transcript (with or without crosstalk) at operation 510. The transcript includes communications between the users during the communication session, and provides timestamps for the communications (e.g., a timestamp for each word or other token of text, etc.).

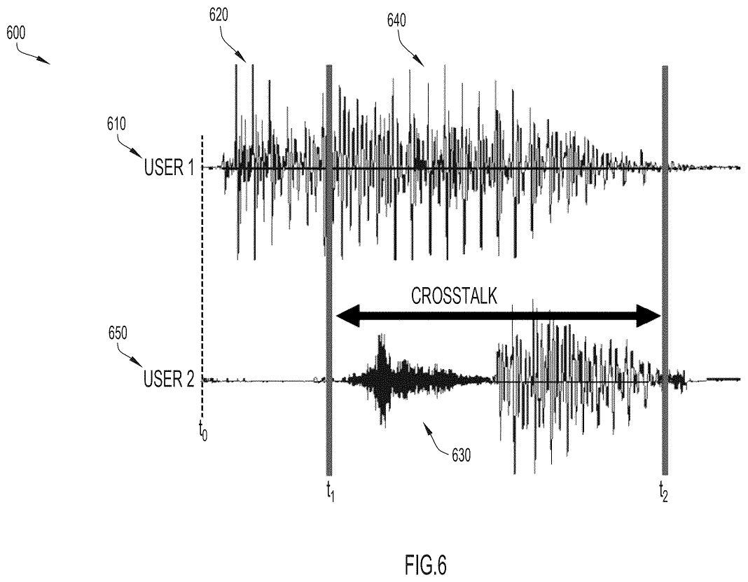

Crosstalk detector 134 analyzes the transcript to identify crosstalk (or simultaneous or overlapping communication between the users) at operation 515. Crosstalk can be automatically detected when participants of a communication session are communicating to each other at the same time. Referring to FIG. 6, graphical representation 600 illustrates an example of audio of user interaction within a communication session between a user 610 (e.g., User 1 as shown in FIG. 6) and a user 650 (e.g., User 2 as shown in FIG. 6). The graphical representation is plotted on an X-axis representing time and a Y-axis representing amplitude. Audio for user 610 includes an audio portion 620 corresponding to sound or speech of user 610. Audio for user 650 includes an audio portion 630 corresponding to sound or speech of user 650. Audio portion 630 overlaps in time with audio portion 620. A crosstalk portion 640 resides in time during overlap of audio portions 620, 630. Crosstalk portion 640 includes sound or speech by each user 610, 650. In other words, the crosstalk portion includes a region of representation 600 including audio portions 620 and 630.

Crosstalk portion 640 can be automatically detected when there is audio from each of users 610, 650 in a portion of the communication session. This may be represented in the transcript based on timestamps for the audio portions of users 610, 650. For example, crosstalk portion 640 may correspond to a period of time within the transcript when audio portions of users 610, 650 are present. By way of example, audio portion 620 may reside between times t₀ and t₂, while audio portion 630 may reside between times t₁ and t₂. Since audio portions 620, 630 each reside between times t₁ and t₂, this region or period of time represents crosstalk portion 640. Crosstalk detector 134 may analyze the timestamps in the transcript to identify crosstalk. Alternatively, crosstalk detector 134 may analyze the audio to detect crosstalk (without text conversion). Speech-to-text converter 132 converts the audio to text as described above to produce the transcript for crosstalk LLM 138. The timestamps of the crosstalk from the audio correspond to the timestamps of the transcript. Crosstalk detector 134 may determine the difference between timestamps for the beginning and end of crosstalk portion 640 (e.g., difference between times t₁ and t₂, etc.), and identify crosstalk when the difference (or duration of the crosstalk) exceeds a threshold, such as five seconds. However, any quantity of seconds may be used, where the threshold may be configurable as a parameter.

When crosstalk is detected as determined at operation 520, prompt generator 135 receives the transcript and identification of crosstalk (e.g., time period of the crosstalk), and determines portions or sections within the transcript preceding and subsequent the crosstalk at operation 525. For example, prompt generator 135 may identify a quantity of sentences (e.g., one to five sentences or clauses, etc.) before and after the crosstalk by comparing the time period of the crosstalk with timestamps within the transcript. Prompt generator 135 generates a prompt for crosstalk LLM 138 of classifier 136 to classify the crosstalk as a good (positive) or bad (negative) user experience. By way of example, the prompt may include the portions preceding and subsequent the crosstalk, the crosstalk, and one or more examples of text for good (positive) and bad (negative) user experiences. However, the prompt may include any suitable information (e.g., the transcript, the crosstalk, the portions preceding and subsequent the crosstalk, examples, various context information, etc.).

Crosstalk LLM 138 processes the prompt to classify the crosstalk as a good (positive) or bad (negative) user interaction (or user experience) at operation 530. The classification of the crosstalk may be based on agreement or affirmation of the users (e.g., contact center agent and user, meeting participants, etc.) within the interaction for an issue (e.g., product/service, topic, etc.). For example, the portions of text of the crosstalk and/or surrounding (preceding and subsequent) the crosstalk indicating an agreement or affirmation indicate a good (or positive) user experience. In contrast, the portions of text of the crosstalk and/or surrounding (preceding and subsequent) the crosstalk indicating interruptions by the users (e.g., one user interrupting the other, etc.), and/or disagreement or dismissive behavior (e.g., a user disagreeing or dismissing the other user, etc.) indicate a bad (or negative) user experience. The prompt for crosstalk LLM 138 may include examples of the text described above for indicating good (positive) and bad (negative) user experiences to direct behavior of the crosstalk LLM for classifying the crosstalk.

Classification module 130 stores the classification and corresponding information in database 127 at operation 535. For example, the classification module may determine various attributes and/or metrics pertaining to the user interaction (e.g., duration of interaction, duration of crosstalk, overall duration for agent interactions, classification result, scores for users, etc.).

The above process repeats from operation 505 for until the communication session has been processed as determined at operation 540. Thus, each instance of crosstalk in the communication session is classified as a good (positive) or bad (negative) experience. The classifications and corresponding information may be used to determine scores for each instance, communication session, and/or user (e.g., contact center agent, meeting participant, etc.).

By way of example, a user interaction within a communication session between the user and a contact center agent for an issue (e.g., support for product/service, etc.) may include:
User: I'm having a problem logging into the online portal and I can see the button you're talking about and I'm really struggling to find it.
Agent: yeah, yeah, I understand.

In this example case, the user and agent are communicating at the same time (based on timestamps). This user interaction is likely an example of a good (or positive) user interaction since there is affirmation of the user by the agent based on the crosstalk.

By way of further example, another user interaction in a communication session between the user and a contact center agent may include:
User: I'm having a problem logging into the online portal and I can see the button you're talking about and I'm really struggling to find it.
Agent: you're pressing the WRONG button, listen to me, listen to what I'm TELLING you, you're pressing the wrong button.

In this example case, the user and agent are communicating at the same time (based on timestamps). This user interaction is likely an example of a bad (or negative) user interaction since there is a lack of understanding (or disagreement) between the user and agent based on the crosstalk.

Alternatively, the communication session may be conducted via textual messages (e.g., without audio, such as by chat, email or other messages, etc.). In this case, the messages (e.g., without speech to text conversion) include, or are associated with, timestamps. The messages are analyzed in substantially the same manner described above to identify silence and/or crosstalk, and classify the silence and/or crosstalk as a good (positive) or bad (negative) experience. In addition, classifier 136 may include one or more machine learning models trained to classify a user interaction based on the silence, crosstalk, or a combination of the silence and crosstalk. The classifier may include one or more machine learning models trained as described above to classify the user interaction (e.g., a machine learning model to classify the user interaction based on silence, a machine learning model to classify the user interaction based on crosstalk, an overall machine learning model to classify the user interaction based on either silence or crosstalk or a combination of silence and crosstalk, a machine learning model to classify the user interaction based on a combination of silence and crosstalk, etc.).

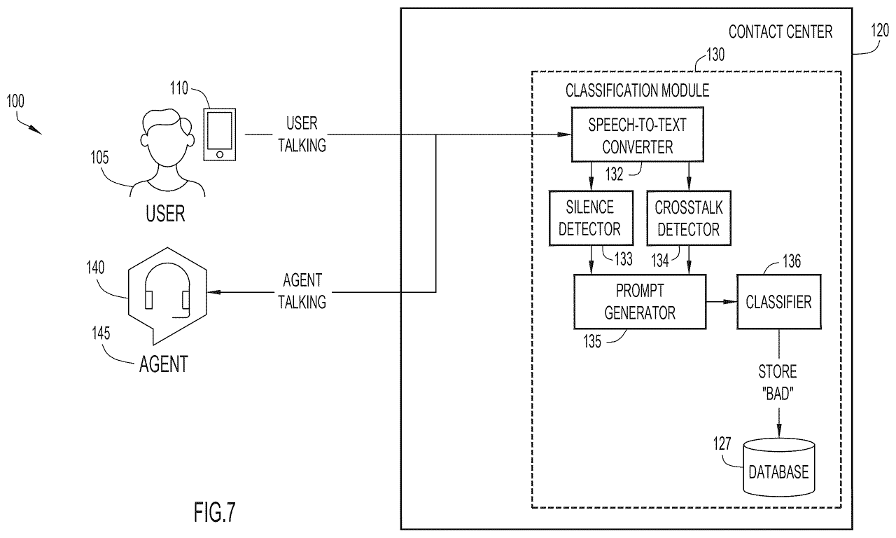

With continued reference to FIGS. 1, 3, 4, 5, and 6, FIG. 7 illustrates classifying a user interaction based on silence and/or crosstalk, according to an example embodiment. Initially, a user 105 communicates (via user device 110) with a contact center agent 145 (via agent device 140) in contact center environment 100 in substantially the same manner described above. Classification module 130 receives audio of the communication session. The audio may be a recording of the communication session, or may be provided in real-time or near-real time during the communication session. In case of the audio being received during the communication session, the audio may be partitioned into segments of any desired time interval or duration (e.g., a few seconds to a few minutes, etc.). Speech-to-text converter 132 converts the audio to text to produce a transcript in substantially the same manner described above. The transcript includes communications between the user and contact center agent during the communication session.

Silence detector 133 detects instances of silence within the communication session, while crosstalk detector 134 detects instances of crosstalk (e.g., simultaneous or overlapping communications between the user and contact center agent) within the communication session in substantially the same manner described above. Prompt generator 135 receives the silence and/or crosstalk detections, and generates prompts for classifier 136 to classify instances of silence and/or crosstalk detected within the communication session in substantially the same manner described above.

Classifier 136 may select from among machine learning models to classify the user interaction (e.g., a machine learning model to classify the user interaction based on silence (e.g., silence LLM 137, etc.), a machine learning model to classify the user interaction based on crosstalk (e.g., crosstalk LLM 138, etc.), an overall machine learning model to classify the user interaction based on either silence or crosstalk or a combination of silence and crosstalk, a machine learning model to classify the user interaction based on a combination of silence and crosstalk, etc.) based on the detections and/or desired configuration (e.g., select silence LLM 137 when detecting silence, select crosstalk LLM 138 when detecting crosstalk, select an overall model when detecting silence and/or crosstalk, etc.).

Classification module 130 stores the classification and corresponding information in database 127. For example, the classification module may determine various attributes and/or metrics pertaining to the user interaction (e.g., duration of interaction, classification result, duration of silence and/or crosstalk, scores for contact center agents, etc.), and may select all or certain classifications for storage of associated information in the database (e.g., storage of information associated with classifications of bad (or negative), storage of information associated with classifications of good (or positive), storage of information for all classifications, etc.).

With continued reference to FIGS. 1, 3, 4, 5, 6, and 7, FIG. 8 illustrates an example user interface 800 for providing information for contact center agents pertaining to user interactions within communication sessions, according to an example embodiment. Initially, classifier 136 classifies instances of silence and crosstalk within communication sessions between contact center agents and users as good (positive) or bad (negative) user experiences, and classification module 130 stores the classification and corresponding information in database 127 in substantially the same manner described above. For example, the classification module may determine various attributes and/or metrics pertaining to the user interaction (e.g., duration of interaction, duration for communication sessions, classification results, scores for agents, etc.).

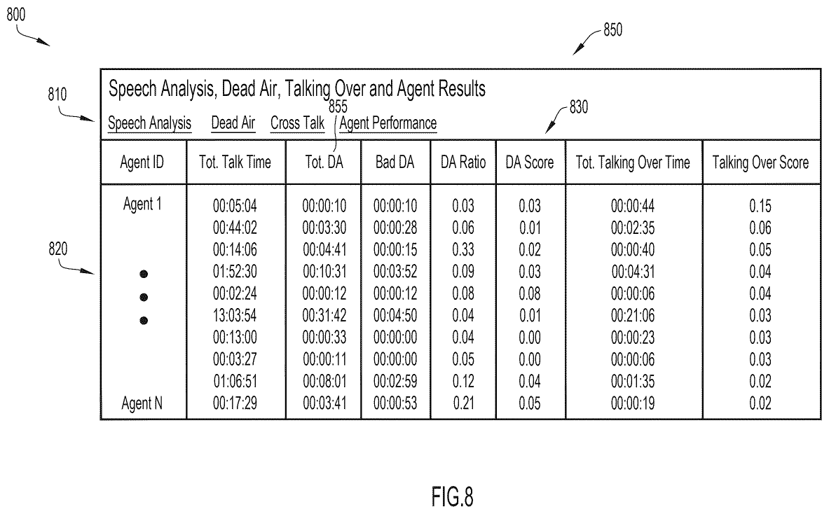

User interface 800 includes a table 850 providing information for contact center agents. The information for table 850 may be retrieved from database 127. Table 850 includes rows 820 for each contact center agent 145 (e.g., AGENT1 to AGENT N as viewed in FIG. 8) and columns 830 for various attributes or metrics (e.g., agent identification, total talk time, total dead air (DA) time, bad DA (e.g., DA time classified as bad), DA ratio, DA score, total talking over (or crosstalk) time, talking over (or crosstalk) score, etc. as viewed in FIG. 8). Cells 855 each reside in table 850 at an intersection of a row and column, and indicate a corresponding value for the agent and attribute or metric whose row and column intersects.

Classification module 130 may obtain and/or determine the values of cells 855 for the attributes and metrics based on the communication sessions, silence and crosstalk detections, and classifications. For example, classification module 130 may determine a score for contact center agents with respect to dead air (or silence) and crosstalk. The dead air (DA) ratio represents an amount of silence, and may be computed for a contact center agent by calculating a ratio of the total dead air time for the contact center agent across captured communication sessions to the total talk time for the contact center agent across the captured communication sessions. The DA score for a contact center agent represents the amount of silence classified as bad (or negative), and may be computed by calculating a ratio of a total duration of dead air time classified as bad for the contact center agent across captured communication sessions to the total talk time for the contact center agent across the captured communication sessions. Further, the DA score for a contact center agent may represent the amount of silence classified as good (or positive), and may be computed by calculating a ratio of a total duration of dead air time classified as good for the contact center agent across captured communication sessions to the total talk time for the contact center agent across the captured communication sessions. These DA values and scores may be normalized to any desired range or scale (e.g., between 0 and 100, etc.).

Similarly, a talking over (crosstalk) ratio for a contact center agent represents an amount of crosstalk, and may be computed for a contact center agent by calculating a ratio of the total talking over (or crosstalk) time for the contact center agent across captured communication sessions to the total talk time for the contact center agent across the captured communication sessions. The talking over (or crosstalk) score for a contact center agent represents the amount of crosstalk classified as bad (or negative), and may be computed by calculating a ratio of a total duration of talking over (or crosstalk) time classified as bad for the contact center agent across captured communication sessions to the total talk time for the contact center agent across the captured user communication sessions. Further, the talking over (or crosstalk) score for a contact center agent may represent the amount of crosstalk classified as good (or positive), and may be computed by calculating a ratio of a total duration of talking over (or crosstalk) time classified as good for the contact center agent across captured communication sessions to the total talk time for the contact center agent across the captured user communication sessions. These crosstalk values and scores may be normalized to any desired range or scale (e.g., between 0 and 100, etc.).

The contact center agents may be ranked based on the DA and/or crosstalk scores. Further, individual calls or other communication sessions between contact center agents and users may be determined that have poor DA and/or crosstalk scores (e.g., compared to a threshold, etc.) to identify problematic communication sessions. For example, a greater DA or crosstalk score (based on classifications of bad silence or crosstalk) indicates a higher occurrence of bad or negative user experiences (e.g., a greater amount or percentage of bad (or negative) user experiences during user interactions, etc.) for a contact center agent across captured communication sessions and can identify problematic communication sessions. Further, a lower DA or crosstalk score (based on classifications of good silence or crosstalk) indicates a lower occurrence of good or positive user experiences (e.g., a lower amount or percentage of good (or positive) user experiences during user interactions, etc.) for a contact center agent across captured communication sessions and can similarly identify problematic communication sessions.

Table 850 may be interactive and enable a user to navigate to additional information. For example, table 850 may further include tabs or links 810 to navigate to various user interface screens (e.g., a speech analysis tab for speech analysis information, a dead air tab for silence information and/or metrics, a crosstalk tab for crosstalk information and/or metrics, and an agent performance tab for agent information and metrics as shown in FIG. 8). By way of example, table 850 reflects actuation of the agent performance tab, but actuation of the other tabs enables display of the corresponding information.

Moreover, table 850 may be ordered (or sorted) on any one of the columns 830. For example, sorting on the DA score column sorts the agents in table 850 based on their dead air (DA) score. Similarly, sorting on the talking over (or crosstalk) score column sorts the agents based on the talking over score. The sorting may be accomplished by actuating a corresponding column header serving as a sort actuator, and may be performed in ascending or descending order.

In addition, one or more cells 855 on table 850 may be in the form of a link. For example, actuating a cell 855 for the DA score of a contact center agent displays a grid that shows all the calls or other communications for that contact center agent, and allows a user to listen, analyze, and navigate directly to problematic portions of a communication session where the silence or dead air occurred.

The information of the table may be retrieved from database 127 and analyzed by routing module 124 to route communications to agents as described below, and/or by classification module 130 to indicate areas for additional training for contact center agents. For example, the DA and crosstalk scores may be used individually or in any combination. By way of example, a combined score for an agent may be determined by combining two or more of the scores (e.g., DA score, crosstalk score, etc.) in any fashion (e.g., summed, average, weighted average by assigning weights based on importance or priority, etc.). The individual and/or combined scores may be used to evaluate performance of the agents for routing or other purposes (e.g., routing, conducting communication sessions with at least one participant selected based on the scores, etc.).

By way of further example, contact center agents with a greater amount of bad (or negative) user interactions may indicate a need for additional training. The communications of the user interactions may be evaluated to determine specific areas of training for the contact center agents (e.g., with less knowledgeable customers, certain subject matter areas, etc.). Classification module 130 may include a machine learning model (e.g., LLM, neural network, etc.) as described above and trained to analyze the user interactions to identify problematic areas.

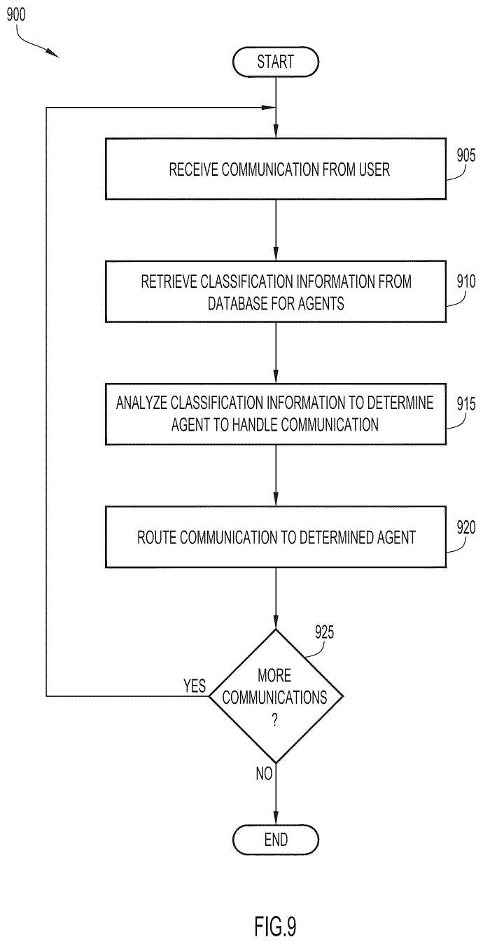

With continued reference to FIGS. 1, 3, 4, 5, 6, 7, and 8, FIG. 9 illustrates a method 900 for routing a communication to an agent of a contact center based on user interactions, according to an example embodiment. Communication processing module 122 of contact center 120 initially receives a communication from user 105 via user device 110 (e.g., an audio or video call, chat, email or other message, etc.) at operation 905. The communication processing module may obtain information about the user and/or communication. For example, the communication processing module may enable interaction with a user (e.g., via an interactive voice response (IVR) system, etc.), or analyze text of messages to obtain information (e.g., reason for the communication, user information, etc.). The information is provided to routing module 124 to route the communication from queue 128 to a contact center agent 145 that can handle the communication. Various attributes and metrics for the contact center agents with respect to user interactions are obtained and stored in database 127 in substantially the same manner described above.

Routing module 124 of contact center 120 obtains information from database 127 pertaining to user interactions with contact center agents 145 at operation 910. The routing module analyzes the information and selects a contact center agent 145 to handle the communication based on the user interactions of the contact center agents at operation 915. For example, the routing module may select the contact center agent based on the DA, crosstalk, and/or combined scores described above (e.g., a contact center agent with the highest scores based on good (or positive) classifications may be selected, a contact center agent with the lowest scores based on bad (or negative) classifications may be selected, etc.). Further, the contact center agent may be selected further based on load balancing or availability (e.g., communications waiting to be handled by the contact center agents, etc.) to improve throughput or performance for processing communications. By way of example, a contact center agent having a low number of communications to be handled (e.g., compared to threshold or other agents) and the best dead air, crosstalk, and/or combined scores may be selected. The contact center agents may be ranked based on the scores (e.g., DA score, crosstalk score, combined score, etc.) for selection. However, any suitable criteria may be used to rank and/or select a contact center agent based on the attributes and metrics associated with user interactions (e.g., DA score, crosstalk score, combined score, etc.).

Routing module 124 routes the communication from queue 128 to an agent device 140 of the selected contact center agent 145 at operation 920. The agent device enables communication between agent 145 and corresponding user 105. The above process repeats from operation 905 until communications are processed as determined at operation 925.

With continued reference to FIGS. 1, 3, 4, 5, 6, 7, 8, and 9, FIG. 10 illustrates routing a communication to an agent of a contact center based on user interactions, according to an example embodiment. Initially, contact center 120 of contact center environment 100 receives a communication from user 105 via user device 110 (e.g., an audio or video call, chat, email or other message, etc.). The contact center may be associated with various agents 145(1), 145(2), 145(3) communicating using corresponding agent devices 140(1), 140(2), 140(3). Various attributes and metrics for the contact center agents with respect to user interactions are obtained and stored in database 127 in substantially the same manner described above.

Contact center 120 may obtain information about the user and/or communication. For example, the contact center may enable interaction with a user (e.g., via an interactive voice response (IVR) system, etc.), or analyze text of messages to obtain information (e.g., reason for the communication, user information, etc.). The information is provided to routing module 124 to route the communication from queue 128 to a contact center agent 145 that can handle the communication.

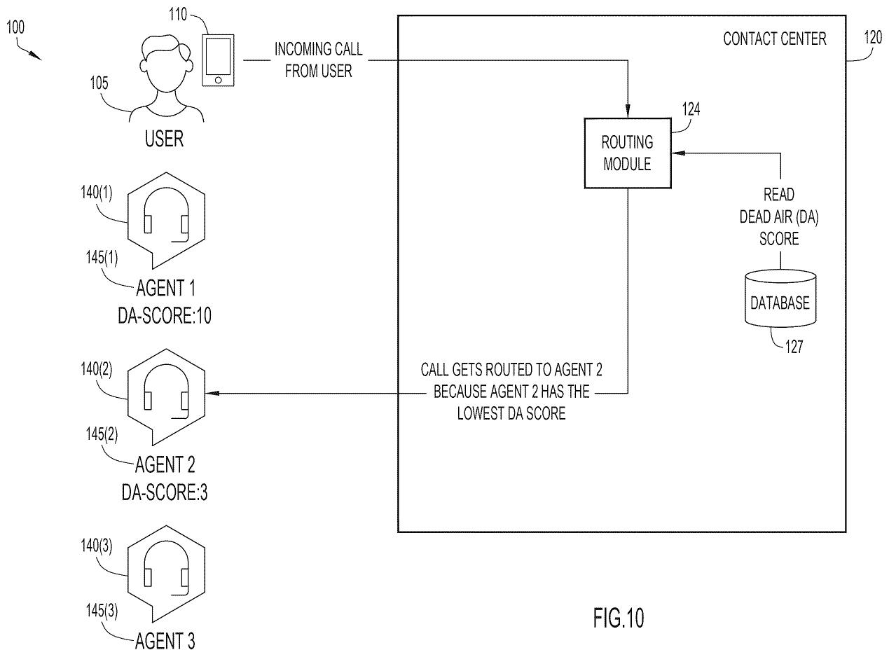

Routing module 124 obtains information from database 127 pertaining to user interactions with contact center agents 145. The routing module analyzes the information and selects a contact center agent 145(2) to handle the communication based on the user interactions of the contact center agents 145(1), 145(2), and 145(3). By way of example, routing decisions for incoming calls or other communications can be based on historical dead air (DA) scores for bad (or negative) user interactions of contact center agents. This ensures that users are routed to contact center agents with the lowest DA score (e.g., a lower DA score indicates a contact center agent has historically less dead air classified as bad (or negative), etc.). The contact center agents may be ranked based on the scores (e.g., DA score, crosstalk score, combined score, etc.) for selection. For example, the routing module may select contact center agent 145(2) based on having the lowest DA score (e.g., a DA score of 3 as viewed in FIG. 10) indicating better performance relative to the other contact center agents 145(1) (e.g., having a DA score of 10 as viewed in FIGS. 10) and 145(3) (e.g., having a DA score of 22 as viewed in FIG. 10). However, any suitable criteria may be used to rank and/or select a contact center agent based on the attributes and metrics associated with user interactions (e.g., DA score, crosstalk score, combined score, etc.)

Routing module 124 routes the communication from queue 128 to an agent device 140(2) of the selected contact center agent 145(2) to enable communication (or conduct a communication session) between user 105 and contact center agent 145(2).

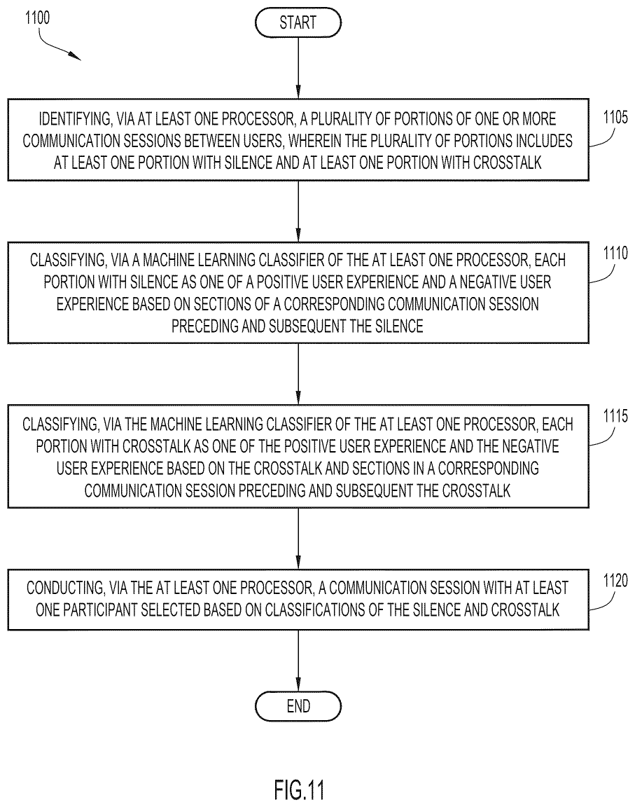

FIG. 11 is a flowchart of an example method 1100 for machine learning classification of user interaction, according to an example embodiment. At operation 1105, a plurality of portions of one or more communication sessions between users is identified. The plurality of portions includes at least one portion with silence and at least one portion with crosstalk. At operation 1110, a machine learning classifier classifies each portion with silence as one of a positive user experience and a negative user experience based on sections of a corresponding communication session preceding and subsequent the silence. At operation 1115, the machine learning classifier classifies each portion with crosstalk as one of the positive user experience and the negative user experience based on the crosstalk and sections in a corresponding communication session preceding and subsequent the crosstalk. At operation 1120, a communication session is conducted with at least one participant selected based on classifications of the silence and crosstalk.

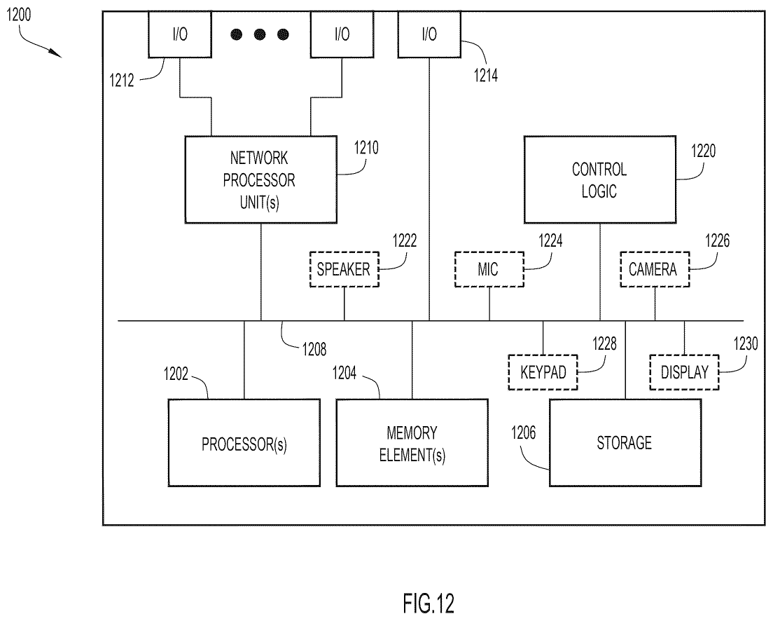

Referring to FIG. 12, FIG. 12 illustrates a hardware block diagram of a computing device 1200 that may perform functions associated with operations discussed herein in connection with the techniques depicted in FIG. 1-11. In various embodiments, a computing device or apparatus or system, such as computing device 1200 or any combination of computing devices 1200, may be configured as any device entity/entities (e.g., network nodes, computer devices, end-user devices, endpoint devices, servers, client devices, communication devices, network devices, processors, switching devices, network interfaces, agent devices, routers, contact center, etc.) as discussed for the techniques depicted in connection with FIG. 1-11 in order to perform operations of the various techniques discussed herein.

In at least one embodiment, computing device 1200 may be any apparatus that may include one or more processor(s) 1202, one or more memory element(s) 1204, storage 1206, a bus 1208, one or more network processor unit(s) 1210 interconnected with one or more network input/output (I/O) interface(s) 1212, one or more I/O interface(s) 1214, and control logic 1220. In various embodiments, instructions associated with logic for computing device 1200 can overlap in any manner and are not limited to the specific allocation of instructions and/or operations described herein.

In at least one embodiment, processor(s) 1202 is/are at least one hardware processor configured to execute various tasks, operations and/or functions for computing device 1200 as described herein according to software and/or instructions configured for computing device 1200. Processor(s) 1202 (e.g., a hardware processor) can execute any type of instructions associated with data to achieve the operations detailed herein. In one example, processor(s) 1202 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1204 and/or storage 1206 is/are configured to store data, information, software, and/or instructions associated with computing device 1200, and/or logic configured for memory element(s) 1204 and/or storage 1206. For example, any logic described herein (e.g., control logic 1220) can, in various embodiments, be stored for computing device 1200 using any combination of memory element(s) 1204 and/or storage 1206. Note that in some embodiments, storage 1206 can be consolidated with memory elements 1204 (or vice versa), or can overlap/exist in any other suitable manner.

In at least one embodiment, bus 1208 can be configured as an interface that enables one or more elements of computing device 1200 to communicate in order to exchange information and/or data. Bus 1208 can be implemented with any architecture designed for passing control, data and/or information between processors, memory elements/storage, peripheral devices, and/or any other hardware and/or software components that may be configured for computing device 1200. In at least one embodiment, bus 1208 may be implemented as a fast kernel-hosted interconnect, potentially using shared memory between processes (e.g., logic), which can enable efficient communication paths between the processes.

In various embodiments, network processor unit(s) 1210 may enable communication between computing device 1200 and other systems, entities, etc., via network I/O interface(s) 1212 to facilitate operations discussed for various embodiments described herein. In various embodiments, network processor unit(s) 1210 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1200 and other systems, entities, etc. to facilitate operations for various embodiments described herein. In various embodiments, network I/O interface(s) 1212 can be configured as one or more Ethernet port(s), Fibre Channel ports, any other I/O port(s), and/or antenna(s)/antenna array(s) now known or hereafter developed. Thus, the network processor unit(s) 1210 and/or network I/O interfaces 1212 may include suitable interfaces for receiving, transmitting, and/or otherwise communicating data and/or information in a network environment.

I/O interface(s) 1214 allow for input and output of data and/or information with other entities that may be connected to computing device 1200. For example, I/O interface(s) 1214 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

With respect to certain entities (e.g., client device, end-user device, endpoint device, network device, network nodes, processors, network interfaces, switching devices, agents, routers, etc.), computing device 1200 may further include, or be coupled to, a speaker 1222 to convey sound, microphone or other sound sensing device 1224, camera or image capture device 1226, a keypad or keyboard 1228 to enter information (e.g., alphanumeric information, etc.), and/or a touch screen or other display 1230. These items may be coupled to bus 1208 or I/O interface(s) 1214 to transfer data with other elements of computing device 1200.

In various embodiments, control logic 1220 can include instructions that, when executed, cause processor(s) 1202 to perform operations, which can include, but not be limited to, providing overall control operations of computing device 1200; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

Present embodiments may provide various technical and other advantages. In an embodiment, routing is performed based on the machine learning classification to appropriate agents which reduces the communication session time and increases throughput and performance for handling communications. This also reduces consumption of processing and memory/storage resources to improve computing performance.

In an embodiment, the machine learning models (and/or LLM prompts) may be continuously updated (or trained) based on feedback related to results. For example, a classification may be indicated as a bad (or negative) experience, while a user may have perceived a good (or positive) experience. The feedback be used to update or train the machine learning models (or LLM prompts) to increase the confidence that the classification reflects a good (or positive) classification (e.g., update or train the machine learning model to increase the probability of a result indicating a good (or positive) classification, alter prompts to produce a result more likely to indicate a good (or positive) classification, etc.). A similar approach may be used for a result indicating a good (or positive) classification, where a user perceives a bad (or negative) experience.

Further, the machine learning models may be continuously updated or trained with acceptable deviations (e.g., from user interactions classified as good (or positive)) in order to classify a user interaction. For example, a contact center agent may yield a greater amount of good (or positive) classifications for user interactions (e.g., based on a script, prior good (or positive) user interactions, etc.). However, the agent may deviate slightly, where the deviation is sufficiently similar to the successful communications and should yield a classification of a good (or positive) user interaction. Deviations (e.g., generated deviations, deviations from prior user interactions and/or the script, etc.) may be used to train (or fine tune or update) the machine learning models to classify the deviations as a good (or positive) interaction. A semantic model may be employed to determine semantic similarity of deviations for training the models (e.g., to generate deviations of sufficient similarity to (or of a sufficient distance from) the successful communications (relative to a threshold), to determine whether deviations are sufficiently similar to (or of a sufficient distance from) successful user interactions (relative to a threshold), etc.). The similarity or distance may be determined (e.g., between feature vectors for the successful user interactions and deviations) using any conventional or other techniques (e.g., Euclidean distance, cosine similarity, etc.). By way of example, the deviations may be used as examples in the prompts for good (or positive) classifications to adjust the silence and crosstalk LLMs.

Thus, the machine learning models (or LLM prompts) may continuously evolve (or be trained) to learn to produce appropriate good (positive) and bad (negative) classifications as communication sessions are conducted.

The programs described herein (e.g., control logic 1220) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

Data relating to operations described herein may be stored within any conventional or other data structures (e.g., files, arrays, lists, stacks, queues, records, etc.) and may be stored in any desired storage unit (e.g., database, data or other stores or repositories, queue, etc.). The data transmitted between device entities may include any desired format and arrangement, and may include any quantity of any types of fields of any size to store the data. The definition and data model for any datasets may indicate the overall structure in any desired fashion (e.g., computer-related languages, graphical representation, listing, etc.).

The present embodiments may employ any number of any type of user interface (e.g., graphical user interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The environment of the present embodiments may include any number of computer or other processing systems (e.g., client or end-user systems, server systems, network devices, storage devices, etc.) and databases or other repositories arranged in any desired fashion, where the present embodiments may be applied to any desired type of computing environment (e.g., cloud computing, client-server, network computing, mainframe, stand-alone systems, datacenters, etc.). The computer or other processing systems employed by the present embodiments may be implemented by any number of any personal or other type of computer or processing system (e.g., desktop, laptop, Personal Digital Assistant (PDA), mobile devices, etc.), and may include any commercially available operating system and any combination of commercially available and custom software. These systems may include any types of monitors and input devices (e.g., keyboard, mouse, voice recognition, etc.) to enter and/or view information.

It is to be understood that the software of the present embodiments may be implemented in any desired computer language and could be developed by one of ordinary skill in the computer arts based on the functional descriptions contained in the specification and flowcharts and diagrams illustrated in the drawings. Further, any references herein of software performing various functions generally refer to computer systems or processors performing those functions under software control. The computer systems of the present embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., Local Area Network (LAN), Wide Area Network (WAN), Intranet, Internet, hardwire, modem connection, wireless, etc.). For example, the functions of the present embodiments may be distributed in any manner among the various network devices, storage devices, and other processing devices or systems, and/or any other intermediary processing devices. The software and/or algorithms described above and illustrated in the flowcharts and diagrams may be modified in any manner that accomplishes the functions described herein. In addition, the functions in the flowcharts, diagrams, or description may be performed in any order that accomplishes a desired operation.

The networks of present embodiments may be implemented by any number of any type of communications network (e.g., LAN, WAN, Internet, Intranet, Virtual Private Network (VPN), etc.). The computer or other processing systems of the present embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., LAN, hardwire, wireless link, Intranet, etc.).

Each of the elements described herein may couple to and/or interact with one another through interfaces and/or through any other suitable connection (wired or wireless) that provides a viable pathway for communications. Interconnections, interfaces, and variations thereof discussed herein may be utilized to provide connections among elements in a system and/or may be utilized to provide communications, interactions, operations, etc. among elements that may be directly or indirectly connected in the system. Any combination of interfaces can be provided for elements described herein in order to facilitate operations as discussed for various embodiments described herein.

In various embodiments, any device entity or apparatus as described herein may store data/information in any suitable volatile and/or non-volatile memory item (e.g., magnetic hard disk drive, solid state hard drive, semiconductor storage device, Random Access Memory (RAM), Read Only Memory (ROM), Erasable Programmable ROM (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more device entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, Digital Signal Processing (DSP) instructions, software [potentially inclusive of object code and source code], etc.) for execution by one or more processor(s), and/or other similar machine, etc. Generally, memory element(s) 1204 and/or storage 1206 can store data, software, code, instructions (e.g., processor instructions), logic, parameters, combinations thereof, and/or the like used for operations described herein. This includes memory elements 1204 and/or storage 1206 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, Compact Disc ROM (CD-ROM), Digital Versatile Disc (DVD), memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any Local Area Network (LAN), Virtual LAN (VLAN), Wide Area Network (WAN) (e.g., the Internet), Software Defined WAN (SD-WAN), Wireless Local Area (WLA) access network, Wireless Wide Area (WWA) access network, Metropolitan Area Network (MAN), Intranet, Extranet, Virtual Private Network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, any device entity or apparatus for various embodiments described herein can encompass network elements (which can include virtualized network elements, functions, etc.) such as, for example, network appliances, forwarders, routers, servers, switches, gateways, bridges, load-balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four device entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ or ‘frame’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more device entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combinations of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

In one form, a method is provided. The method comprises: identifying, via at least one processor, a plurality of portions of one or more communication sessions between users, wherein the plurality of portions includes at least one portion with silence and at least one portion with crosstalk; classifying, via a machine learning classifier of the at least one processor, each portion with silence as one of a positive user experience and a negative user experience based on sections of a corresponding communication session preceding and subsequent the silence; classifying, via the machine learning classifier of the at least one processor, each portion with crosstalk as one of the positive user experience and the negative user experience based on the crosstalk and sections in a corresponding communication session preceding and subsequent the crosstalk; and conducting, via the at least one processor, a communication session with at least one participant selected based on classifications of the silence and crosstalk.

In one example, the machine learning classifier includes a first large language model to classify each portion with silence, and a second large language model to classify each portion with crosstalk.

In one example, classifying each portion with silence comprises classifying each portion with silence based on the sections preceding and subsequent the silence indicating resolution of an issue, receipt of appropriate information for the issue, and/or an expectedness of the silence.

In one example, classifying each portion with crosstalk comprises classifying each portion with crosstalk based on the crosstalk and/or the sections preceding and subsequent the crosstalk indicating an agreement or affirmation by the users.

In one example, the users include an agent of a contact center, and the method further comprises generating, via the at least one processor, one or more scores for the agent based on classifications for the silence and crosstalk.

In one example, the method further comprises routing, via the at least one processor, a communication to a corresponding agent of the contact center based on the one or more scores.

In one example, the one or more communication sessions between the users include an online meeting.

In another form, an apparatus is provided. The apparatus comprises a computer device; memory; and at least one processor configured to perform operations comprising: identifying a plurality of portions of one or more communication sessions between users, wherein the plurality of portions includes at least one portion with silence and at least one portion with crosstalk; classifying, via a machine learning classifier, each portion with silence as one of a positive user experience and a negative user experience based on sections of a corresponding communication session preceding and subsequent the silence; classifying, via the machine learning classifier, each portion with crosstalk as one of the positive user experience and the negative user experience based on the crosstalk and sections in a corresponding communication session preceding and subsequent the crosstalk; and conducting a communication session with at least one participant selected based on classifications of the silence and crosstalk.

In another form, one or more non-transitory computer readable storage media are provided. The one or more non-transitory computer readable storage media are encoded with processing instructions that, when executed by one or more processors, cause the one or more processors to perform operations comprising: identifying a plurality of portions of one or more communication sessions between users, wherein the plurality of portions includes at least one portion with silence and at least one portion with crosstalk; classifying, via a machine learning classifier, each portion with silence as one of a positive user experience and a negative user experience based on sections of a corresponding communication session preceding and subsequent the silence; classifying, via the machine learning classifier, each portion with crosstalk as one of the positive user experience and the negative user experience based on the crosstalk and sections in a corresponding communication session preceding and subsequent the crosstalk; and conducting a communication session with at least one participant selected based on classifications of the silence and crosstalk.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
identifying, via at least one processor, a plurality of portions of one or more communication sessions between users, wherein the plurality of portions includes at least one portion with silence and at least one portion with crosstalk;
classifying, via a machine learning classifier of the at least one processor, each portion with silence as one of a positive user experience and a negative user experience based on sections of a corresponding communication session preceding and subsequent the silence;
classifying, via the machine learning classifier of the at least one processor, each portion with crosstalk as one of the positive user experience and the negative user experience based on the crosstalk and sections in a corresponding communication session preceding and subsequent the crosstalk; and
conducting, via the at least one processor, a communication session with at least one participant selected based on classifications of the silence and crosstalk.

2. The method of claim 1, wherein the machine learning classifier includes:
a first large language model to classify each portion with silence; and
a second large language model to classify each portion with crosstalk.

3. The method of claim 1, wherein classifying each portion with silence comprises:
classifying each portion with silence based on the sections preceding and subsequent the silence indicating resolution of an issue, receipt of appropriate information for the issue, and/or an expectedness of the silence.

4. The method of claim 1, wherein classifying each portion with crosstalk comprises:
classifying each portion with crosstalk based on the crosstalk and/or the sections preceding and subsequent the crosstalk indicating an agreement or affirmation by the users.

5. The method of claim 1, wherein the users include an agent of a contact center, and the method further comprises:
generating, via the at least one processor, one or more scores for the agent based on classifications for the silence and crosstalk.

6. The method of claim 5, further comprising:
routing, via the at least one processor, a communication to a corresponding agent of the contact center based on the one or more scores.

7. The method of claim 1, wherein the one or more communication sessions between the users include an online meeting.

8. An apparatus comprising:
a computer device;
memory; and
at least one processor configured to perform operations comprising:
identifying a plurality of portions of one or more communication sessions between users, wherein the plurality of portions includes at least one portion with silence and at least one portion with crosstalk;
classifying, via a machine learning classifier, each portion with silence as one of a positive user experience and a negative user experience based on sections of a corresponding communication session preceding and subsequent the silence;
classifying, via the machine learning classifier, each portion with crosstalk as one of the positive user experience and the negative user experience based on the crosstalk and sections in a corresponding communication session preceding and subsequent the crosstalk; and
conducting a communication session with at least one participant selected based on classifications of the silence and crosstalk.

9. The apparatus of claim 8, wherein the machine learning classifier includes:
a first large language model to classify each portion with silence; and
a second large language model to classify each portion with crosstalk.

10. The apparatus of claim 8, wherein classifying each portion with silence comprises:
classifying each portion with silence based on the sections preceding and subsequent the silence indicating resolution of an issue, receipt of appropriate information for the issue, and/or an expectedness of the silence.

11. The apparatus of claim 8, wherein classifying each portion with crosstalk comprises:
classifying each portion with crosstalk based on the crosstalk and/or the sections preceding and subsequent the crosstalk indicating an agreement or affirmation by the users.

12. The apparatus of claim 8, wherein the users include an agent of a contact center, and the at least one processor is further configured to perform operations comprising:
generating one or more scores for the agent based on classifications for the silence and crosstalk; and
routing a communication to a corresponding agent of the contact center based on the one or more scores.

13. The apparatus of claim 8, wherein the one or more communication sessions between the users include an online meeting.

14. One or more non-transitory computer readable storage media encoded with processing instructions that, when executed by one or more processors, cause the one or more processors to perform operations comprising:
identifying a plurality of portions of one or more communication sessions between users, wherein the plurality of portions includes at least one portion with silence and at least one portion with crosstalk;
classifying, via a machine learning classifier, each portion with silence as one of a positive user experience and a negative user experience based on sections of a corresponding communication session preceding and subsequent the silence;
classifying, via the machine learning classifier, each portion with crosstalk as one of the positive user experience and the negative user experience based on the crosstalk and sections in a corresponding communication session preceding and subsequent the crosstalk; and
conducting a communication session with at least one participant selected based on classifications of the silence and crosstalk.

15. The one or more non-transitory computer readable storage media of claim 14, wherein the machine learning classifier includes:
a first large language model to classify each portion with silence; and
a second large language model to classify each portion with crosstalk.

16. The one or more non-transitory computer readable storage media of claim 14, wherein classifying each portion with silence comprises:
classifying each portion with silence based on the sections preceding and subsequent the silence indicating resolution of an issue, receipt of appropriate information for the issue, and/or an expectedness of the silence.

17. The one or more non-transitory computer readable storage media of claim 14, wherein classifying each portion with crosstalk comprises:
classifying each portion with crosstalk based on the crosstalk and/or the sections preceding and subsequent the crosstalk indicating an agreement or affirmation by the users.

18. The one or more non-transitory computer readable storage media of claim 14, wherein the users include an agent of a contact center, and the processing instructions further cause the one or more processors to perform operations comprising:
generating one or more scores for the agent based on classifications for the silence and crosstalk.

19. The one or more non-transitory computer readable storage media of claim 18, wherein the processing instructions further cause the one or more processors to perform operations comprising:
routing a communication to a corresponding agent of the contact center based on the one or more scores.

20. The one or more non-transitory computer readable storage media of claim 14, wherein the one or more communication sessions between the users include an online meeting.
